(19) United States
(12) Patent Application Publication
(10) Pub. No.: US 2017/0139796 A1
(43) Pub. Date: May 18, 2017

(54) BUS INTERFACE CARD DETECTION SYSTEM AND METHOD FOR DETECTING BUS INTERFACE CARD

(71) Applicants: INVENTEC (PUDONG) TECHNOLOGY CORPORATION, SHANGHAI (CN); INVENTEC CORPORATION, TAIPEI CITY (TW)

(72) Inventor: Zheng-yen HE, TAIPEI CITY (TW)

(21) Appl. No.: 15/086,159

(22) Filed: Mar. 31, 2016

(30) Foreign Application Priority Data
Nov. 16, 2015 (CN) 201510785446.4

(51) Int. Cl. G06F 11/30; G06F 13/40; G06F 13/42

(52) U.S. Cl. CPC G06F 11/3027; G06F 13/4282; G06F 13/4068; G06F 11/3051

(57) ABSTRACT

A bus interface card detection system is provided herein for detecting bus interface cards of an electronic device, which includes a reading unit for receiving a detection instruction from the electronic device and reading parameters from the bus interface cards according to the detection instruction wherein the parameters include a present operating value and a maximum operating value corresponding to the present operating value, and a determining unit for receiving the parameters from the reading unit and determining whether the present operating value is greater than the corresponding maximum operating value or not, according to the parameters. If the present operating value is greater than the corresponding maximum operating value, the determining unit determines that the bus interface card is incompatible with an operation specification supported by the electronic device.

### FIELD OF THE INVENTION

The present invention relates to a bus interface card detection system and a method for detecting a bus interface card, and more particularly to a bus interface card detection system and a method for detecting a bus interface card which can simultaneously detect a plurality of Peripheral Component Interconnect Express (PCIe) cards.

### BACKGROUND OF THE INVENTION

In a prior art detection system, if a user wants to detect operating states of bus interface cards mounted on an electronic device (e.g., a server or a computer), for example, to detect PCIe cards mounted on the electronic device which has interfaces supporting PCIe, the user firstly needs to click into an interface of a Device Manager to select a PCIe device, and then looks for operating values (such as a present connection speed value, a maximum connection speed value, and so on) of a PCIe card from fields of detailed information of the PCIe device. The user can judge whether the PCIe card is compatible with a speed supported by the electronic device or not according to obtained values.

However, the conventional electronic device usually comprises a plurality of PCIe slots, and each PCIe slot allows plugging in a corresponding PCIe card. If the user wants to detect the operating states of all of the PCIe cards, it will consume a plurality of time from clicking into the interface of the Device Manager to recording and comparing the operating values of all of the PCIe cards. Therefore, it is necessary to provide a detection system and a method adapted to the detection system to solve the above-mentioned technical problems.

### SUMMARY OF THE INVENTION

In order to solve the above-mentioned technical problems, an objective of the present invention is to provide a bus interface card detection system and a method for detecting a bus interface card for quickly and simultaneously detecting operating values and operating states of all of the bus interface cards (such as PCIe cards) of an electronic device, and without requiring time-consuming repeated searching, recording, and comparing of each PCIe card, thereby improving the efficiency of detection.

In order to achieve the above object, the present invention provides a bus interface card detection system for detecting a bus interface card of an electronic device. The bus interface card detection system comprises: a reading unit coupled with the bus interface card, for receiving a detection instruction from the electronic device and reading parameters from the bus interface card according to the detection instruction, where the parameters include a present operating value and a maximum operating value corresponding to the present operating value; and a determining unit coupled with the reading unit, for receiving the parameters from the reading unit and determining whether the present operating value is greater than the corresponding maximum operating value or not, according to the parameters, wherein if the present operating value of the bus interface card is greater than the corresponding maximum operating value, the determining unit determines that the bus interface card is incompatible with an operation specification supported by the electronic device.

In one preferred embodiment of the present invention, the bus interface card detection system further comprises a display controlling unit respectively coupled with the reading unit and a display screen of the electronic device, the display controlling unit is used for receiving the parameters from the reading unit, thereby displaying the parameters on the display screen of the electronic device.

In one preferred embodiment of the present invention, the bus interface card detection system further comprises an alarm unit respectively coupled with the determining unit and the display controlling unit, if the determining unit determines that the bus interface card is incompatible with an operation specification supported by the electronic device, the alarm unit generates an alert message, and the alarm unit transmits the alert message to the display controlling unit, thereby displaying the alert message on the display screen.

In one preferred embodiment of the present invention, the parameters read by the reading unit comprise a present connection speed value and a maximum connection speed value.

In one preferred embodiment of the present invention, the parameters read by the reading unit comprise a present bandwidth value and a maximum bandwidth value.

In order to achieve the above objects, the present invention also provides a method for detecting a bus interface card of an electronic device, comprising the steps of: receiving a detection instruction from the electronic device and reading, by a reading unit, parameters from the bus interface card, according to the detection instruction, where the parameters include a present operating value and a maximum operating value corresponding to the present operating value; and receiving the parameters from the reading unit and determining whether the present operating value is greater than the corresponding maximum operating value or not, according to the parameters, by a determining unit coupled with the reading unit, wherein if the present operating value of the bus interface card is greater than the corresponding maximum operating value, the determining unit determines that the bus interface card is incompatible with an operation specification supported by the electronic device.

In one preferred embodiment of the present invention, after the step of reading the parameters from the bus interface card by the reading unit, the method for detecting the bus interface card further comprises the step of: receiving the parameters from the reading unit by a display controlling unit, thereby displaying the parameters on a display screen of the electronic device, wherein the display controlling unit is coupled with the reading unit and the display screen of the electronic device.

In one preferred embodiment of the present invention, after the step of determining the bus interface card is incompatible with the operation specification supported by the electronic device by the determining unit, the method for detecting the bus interface card further comprises the step of: generating an alert message by an alarm unit, and transmitting the alert message to the display controlling unit by the alarm unit, thereby displaying the alert message on the display screen, wherein the alarm unit is respectively coupled with the determining unit and the display controlling unit.

In one preferred embodiment of the present invention, the parameters comprise a present connection speed value and a maximum connection speed value.

In one preferred embodiment of the present invention, the parameters comprise a present bandwidth value and a maximum bandwidth value.

In order to achieve the above object, the present invention also provides a bus interface card detection system for detecting a bus interface card of an electronic device. The bus interface card detection system comprises: a reading unit coupled with the bus interface card, for receiving a detection instruction from the electronic device and reading parameters from the bus interface card according to the detection instruction, where the parameters include a present operating value and a maximum operating value corresponding to the present operating value; a determining unit coupled with the reading unit, for receiving the parameters from the reading unit and determining whether the present operating value is greater than the corresponding maximum operating value or not, according to the parameters, wherein if the present operating value of the bus interface card is greater than the corresponding maximum operating value, the determining unit determines that the bus interface card is incompatible with an operation specification supported by the electronic device; and an alarm unit coupled with the determining unit, if the determining unit determines that the bus interface card is incompatible with an operation specification supported by the electronic device, the alarm unit generates an alert message.

### BRIEF DESCRIPTION OF THE DRAWINGS

FIG. 1 depicts a functional block diagram of a bus interface card detection system according to a first preferred embodiment of the present invention;

FIG. 2 depicts a flow chart of a method for detecting a bus interface card, in connection with the bus interface card detection system according to the first preferred embodiment of the present invention;

FIG. 3 depicts a functional block diagram of a bus interface card detection system according to a second preferred embodiment of the present invention; and

FIG. 4 depicts a flow chart of a method for detecting a bus interface card, in connection with the bus interface card detection system according to the second preferred embodiment of the present invention.

### DETAILED DESCRIPTION OF THE INVENTION

The structure and the technical means adopted by the present invention to achieve the above and other objects can be best understood by referring to the following detailed description of the preferred embodiments and the accompanying drawings.

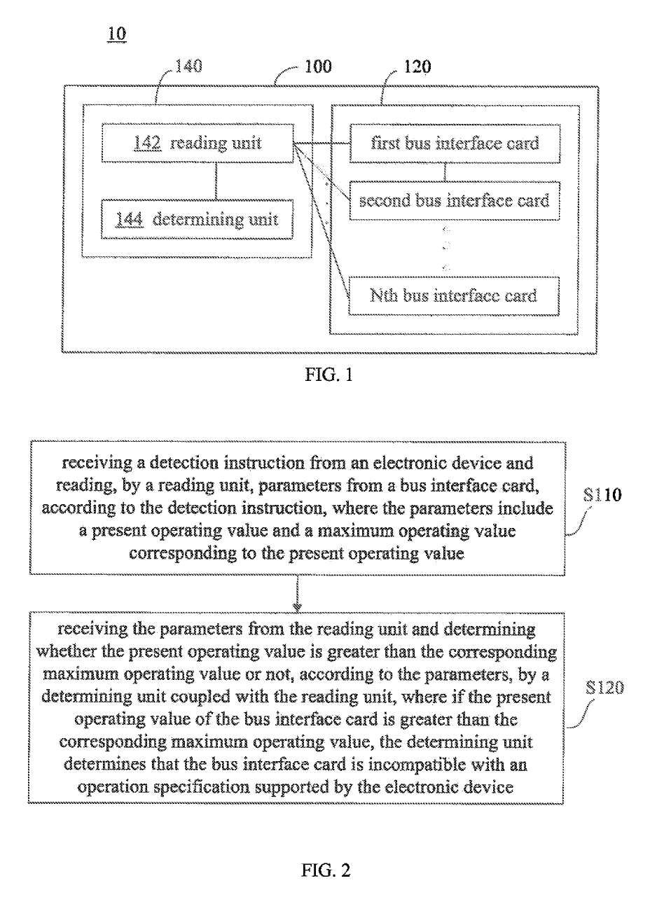

Please refer to FIG. 1, which depicts a functional block diagram of a bus interface card detection system 140 according to a first preferred embodiment of the present invention, where the bus interface card detection system 140 is used for detecting bus interface cards 120 which are mounted on a mainframe 100 of an electronic device 10. Specifically, the mainframe 100 of the electronic device 10 is provided with a plurality of bus interface slots for respectively accommodating a plurality of corresponding bus interface cards 120. In FIG. 1, the plurality of bus interface cards 120 are represented by a first bus interface card, a second bus interface card . . . , and an Nth bus interface card. In the first preferred embodiment of the present invention, the plurality of bus interface slots are plurality of Peripheral Component Interconnect Express (PCIe) slots, for accommodating a plurality of Peripheral Component Interconnect Express cards, but the present invention is not limited thereto.

As shown in FIG. 1, the bus interface card detection system 140 is installed in the mainframe 100 of the electronic device 10, for acquiring data (such as specific operating parameters) from one or more than one of the bus interface cards 120 which are being detected. The bus interface card detection system 140 at least comprises a reading unit 142 and a determining unit 144 which is coupled with the reading unit 142. After a user inputs a detection instruction into the electronic device 10, the reading unit 142 receives the detection instruction from the electronic device 10, and reads parameters from one or more than one of the bus interface cards 120 which are being detected, according to the detection instruction, where the parameters read by the reading unit 142 comprise at least one present operating value (e.g., a present connection speed value, a present bandwidth value, etc.) and at least one maximum operating value corresponding to the present operating value (e.g., a maximum connection speed value, a maximum bandwidth value, etc.) of each of the bus interface cards 120.

As shown in FIG. 1, the determining unit 144 is used for receiving the parameters from the reading unit 142, and determining the present operating value of the detected bus interface card 120 is greater than the corresponding maximum operating value or not, according to the parameters. If the determining unit 144 detects that the present operating value in one of the detected bus interface cards is greater than the corresponding maximum operating value, the determining unit 144 determines that the detected bus interface card 120 is incompatible with an operation specification supported by the electronic device 10. To be specific, in the first preferred embodiment of the present invention, the determining unit 144 is used for determining whether the present connection speed of each of the bus interface cards 120 is greater than the maximum connection speed or not, and/or determining whether the present bandwidth of each of the bus interface cards 120 is greater than the maximum bandwidth or not. Moreover, if the present connection speed of one of the detected bus interface cards 120 is greater than the corresponding maximum connection speed, and/or if the present bandwidth is greater than the corresponding maximum bandwidth, the determining unit 144 determines that the detected bus interface card 120 is incompatible with the operation specification supported by the electronic device 10.

Please refer to FIG. 2, which depicts a flow chart of a method for detecting the bus interface cards 120, in connection with the bus interface card detection system 140 according to the first preferred embodiment of the present invention; please also refer to the bus interface card detection system 140 (shown in FIG. 1) in order to allow easy understanding of the method for detecting the bus interface cards 120 of the present invention. The method for detecting the bus interface cards 120 comprises the following steps. When the bus interface card detection system 140 receives a detection instruction from an operating system of the electronic device 10 to detect one or more than one of the bus interface cards 120 which are being detected, the bus interface card detection system 140 firstly performs a step S110: receiving a detection instruction from the electronic device 10 and reading, by the reading unit 142, the parameters from one or more than one of the bus interface cards, according to the detection instruction. The parameters read by the reading unit 142 comprise at least one present operating value (e.g., a present connection speed value, a present bandwidth value, etc.) and at least one maximum operating value corresponding to the present operating value (e.g., a maximum connection speed value, a maximum bandwidth value, etc.)

As shown in FIG. 1 and FIG. 2, after the reading unit 142 of the bus interface card detection system 140 reads the parameters from one or more than one of the bus interface cards 120, the bus interface card detection system 140 performs a step S120: receiving the parameters from the reading unit 142 and determining whether the present operating value is greater than the corresponding maximum operating value or not, according to the parameters, by the determining unit 144 which is coupled with the reading unit 142. If the present operating value of one of the detected bus interface cards 120 is greater than the corresponding maximum operating value, the determining unit 144 determines that the detected bus interface card 120 is incompatible with the operation specification supported by the electronic device 10. Specifically, in the first preferred embodiment of the present invention, the determining unit 144 is used for determining whether the present connection speed of each of the bus interface cards 120 is greater than the maximum connection speed or not, and/or determining whether the present bandwidth of each of the bus interface cards 120 is greater than the maximum bandwidth or not. Moreover, if the present connection speed of one of the detected bus interface cards 120 is greater than the corresponding maximum connection speed, and/or if the present bandwidth is greater than the corresponding maximum bandwidth, the determining unit 144 determines that the detected bus interface card 120 is incompatible with the operation specification supported by the electronic device 10.

As mentioned above, by using the bus interface card detection system 140 and the method for detecting the bus interface card according to the first preferred embodiment of the present invention, the operating states of one or more than one of the bus interface cards mounted on the electronic device 10 will be quickly detected. For example, one thing the user should do is to input the detection instruction into the electronic device 10, the bus interface card detection system 140 of the present invention will quickly acquire the information of each of the bus interface cards 120 which are being detected, and then the present connection speed and the maximum connection speed and/or the present bandwidth and the maximum bandwidth of each of the bus interface cards 120 will be compared, so as to determine whether a bus interface card 120 which is incompatible with the operation specification supported by the electronic device 10 is exists or not, so that the user can quickly detect one or more than one of the bus interface cards 120.

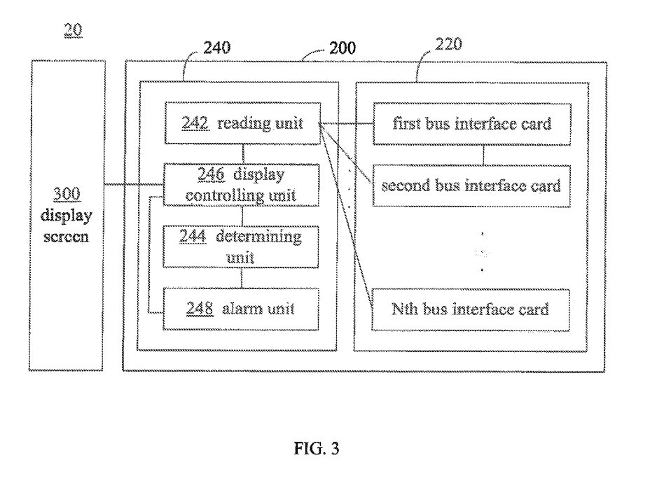

Please refer to FIG. 3, which depicts a functional block diagram of a bus interface card detection system 240 according to a second preferred embodiment of the present invention, where the bus interface card detection system 240 is used for detecting bus interface cards 220 which are mounted on a mainframe 200 of an electronic device 20. The electronic device 20 comprises the mainframe 200 and a display screen 300. Specifically, the mainframe 200 of the electronic device 20 is provided with a plurality of bus interface slots for respectively accommodating a plurality of corresponding bus interface cards 220. In FIG. 3, the plurality of bus interface cards 220 are represented by a first bus interface card, a second bus interface card . . . , and an Nth bus interface card.

As shown in FIG. 3, the bus interface card detection system 240 is installed in the mainframe 200 of the electronic device 20, for acquiring data (such as specific parameters) from one or more than one of the bus interface cards 220. The bus interface card detection system 240 at least comprises a reading unit 242, a determining unit 244, a display controlling unit 246, and an alarm unit 248, where the reading unit 242 is coupled with each of the bus interface cards 220, and the reading unit 242, the determining unit 244, the display controlling unit 246, and the alarm unit 248 are coupled with each other. It should be understood that due to the functions of the reading unit 242 and the determining unit 244 of the second preferred embodiment of the present invention are similar to the reading unit 142 and the determining unit 144 of the first preferred embodiment of the present invention, and therefore are not described herein. In addition, in the second preferred embodiment of the present invention, the display controlling unit 246 is coupled with the reading unit 242 and the display screen 300 of the electronic device 20, for receiving the parameters of one or more than one of the bus interface cards 220 from the reading unit 242, thereby displaying the parameters on the display screen 300 of the electronic device 20. The parameters presenting on the display screen 300 may be embodied, for example, as a table format, a textual format, or an image, but the present invention is not limited thereto. Furthermore, if the determining unit 244 determines that one of the bus interface cards 220 is incompatible with the operation specification supported by the electronic device 20, the alarm unit 248 coupled with the determining unit 244 and the display controlling unit 246 will generate an alert message, and then the alarm unit 248 transmits the alert message to the display controlling unit 246, thereby displaying the alert message on the display screen 300.

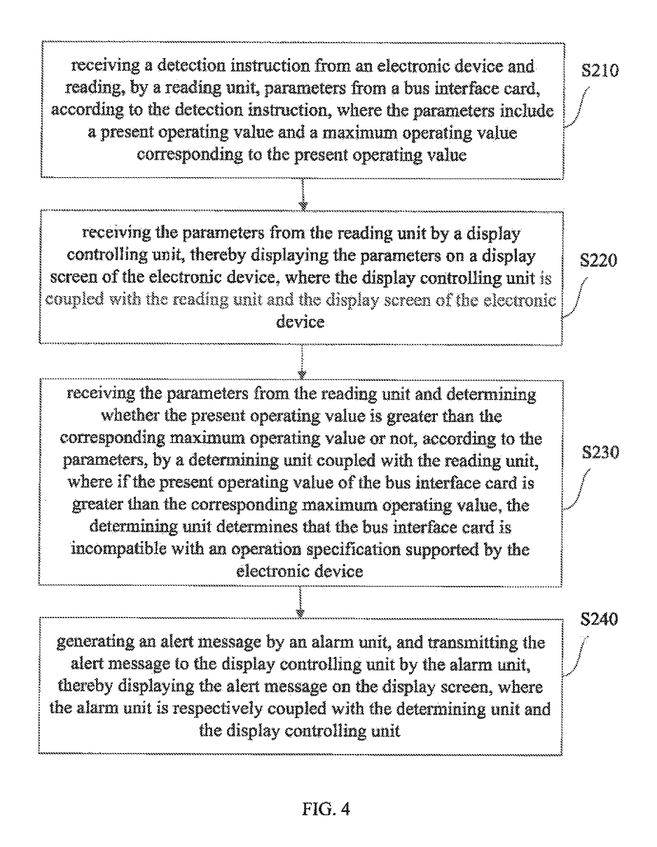

Please refer to FIG. 4, which depicts a flow chart of a method for detecting a bus interface card, in connection with the bus interface card detection system 240 according to the second preferred embodiment of the present invention; please also refer to the bus interface card detection system 240 (shown in FIG. 3) in order to allow easy understanding of the method for detecting the bus interface cards 220 of the present invention. The method for detecting the bus interface cards 220 comprises the following steps. When the bus interface card detection system 240 receives a detection instruction from an operating system of the electronic device 20 to detect one or more than one of the bus interface cards 220, the bus interface card detection system 240 firstly performs a step S210: receiving the detection instruction from the electronic device 20 and reading, by the reading unit 242, the parameters from one or more than one of the bus interface cards, according to the detection instruction. The parameters read by the reading unit 242 comprise at least one present operating value (e.g., a present connection speed value, a present bandwidth value, etc.) and at least one maximum operating value corresponding to the present operating value (e.g., a maximum connection speed value, a maximum bandwidth value, etc.)

As shown in FIG. 3 and FIG. 4, after the reading unit 242 of the bus interface card detection system 240 reads the parameters from one or more than one of the bus interface cards 220, the bus interface card detection system 240 performs a step S220: receiving the parameters from the reading unit 242 by the display controlling unit 246, thereby displaying the parameters on the display screen 300 of the electronic device 20. The parameters presenting on the display screen 300 may be embodied, for example, as a table format, a textual format, or an image, but the present invention is not limited thereto.

As shown on FIG. 3 and FIG. 4, after the bus interface card detection system 240 displays the parameters of each of the bus interface cards 220 on the display screen 300 of the electronic device 20, the bus interface card detection system 240 performs a step S230: receiving the parameters from the reading unit 242 and determining whether the present operating value is greater than the corresponding maximum operating value or not, according to the parameters, by the determining unit 244. If the present operating value of one of the detected bus interface cards 120 is greater than the corresponding maximum operating value, the determining unit 244 determines that the detected bus interface card 220 is incompatible with the operation specification supported by the electronic device 20. Specifically, in the second preferred embodiment of the present invention, the determining unit 244 is used for determining whether the present connection speed of each of the bus interface cards 220 is greater than the maximum connection speed or not, and/or determining whether the present bandwidth of each of the bus interface cards 220 is greater than the maximum bandwidth or not. Moreover, if the present connection speed of one of the detected bus interface cards 220 is greater than the corresponding maximum connection speed, and/or if the present bandwidth is greater than the corresponding maximum bandwidth, the determining unit 244 determines that the detected bus interface card 220 is incompatible with the operation specification supported by the electronic device 20. It should be noted that in the other embodiments the sequence of performing the step S220 and the step S230 can be exchanged.

As shown in FIG. 3 and FIG. 4, after the determining unit 244 of the bus interface card detection system 240 determines that one of the bus interface cards 220 is incompatible with the operation specification supported by the electronic device 20, the bus interface card detection system 240 performs a step S240: generating an alert message by the alarm unit 248, and then transmitting the alert message to the display controlling unit 246 by the alarm unit 248, thereby controlling the display controlling unit 246 to display the alert message on the display screen 300, where the alert message can be performed by, for example, outputting an audible alarm and/or displaying an error window, but the present invention is not limited thereto.

In summary, by using the bus interface card detection system 240 and the method for detecting the bus interface card according to the second preferred embodiment of the present invention, the operating states of one or more than one of the bus interface cards 220 mounted on the electronic device 20 will be quickly detected. For example, one thing the user should do is to input the detection instruction into the electronic device 20, the bus interface card detection system 240 of the present invention will quickly acquire the information of each of the bus interface cards 220 which are being detected, and then the present connection speed and the maximum connection speed and/or the present bandwidth and the maximum bandwidth of each of the bus interface cards 220 will be compared, so as to determine whether a bus interface card 220 which is incompatible with the operation specification supported by the electronic device 20 is exists or not, so that the user can quickly detect one or more than one of the bus interface cards 220. On the other hand, since the bus interface card detection system 240 is provided with the display controlling unit 246 and the alarm unit 248, the bus interface card detection system 240 can make the acquired data and the compared result on to be displayed on the display screen 300 of the electronic device 20, so that the user can promptly obtain the current information of each of the bus interface cards 220. Moreover, when the bus interface card detection system 240 determines that there is a bus interface card 220 which is incompatible with the operation specification supported by the electronic device 20, the user can explicitly know which bus interface card 220 is abnormal.

The above descriptions are merely preferable embodiments of the present invention, and are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

What is claimed is:

1. A bus interface card detection system for detecting at least one bus interface card of an electronic device, the bus interface card detection system comprising:
a reading unit coupled with the at least one bus interface card, for receiving a detection instruction from the electronic device and reading a plurality of parameters from the at least one bus interface card according to the detection instruction, wherein the plurality of parameters include at least one present operating value and at least one maximum operating value corresponding to the present operating value; and
a determining unit coupled with the reading unit, for receiving the plurality of parameters from the reading unit and determining whether the at least one present operating value is greater than the corresponding at least one maximum operating value or not, according to the plurality of parameters, wherein if the at least one present operating value of the at least one bus interface card is greater than the corresponding at least one maximum operating value, the determining unit determines that the at least one bus interface card is incompatible with an operation specification supported by the electronic device.

2. The bus interface card detection system as claimed in claim 1 further comprising a display controlling unit respectively coupled with the reading unit and a display screen of the electronic device, wherein the display controlling unit is used for receiving the plurality of parameters from the reading unit, thereby displaying the plurality of parameters on the display screen of the electronic device.

3. The bus interface card detection system as claimed in claim 2 further comprising an alarm unit respectively coupled with the determining unit and the display controlling unit, wherein if the determining unit determines that the at least one bus interface card is incompatible with an operation specification supported by the electronic device, the alarm unit generates an alert message, and the alarm unit transmits the alert message to the display controlling unit, thereby displaying the alert message on the display screen.

4. The bus interface card detection system as claimed in claim 1, wherein the plurality of parameters read by the reading unit comprise a present connection speed value and a maximum connection speed value.

5. The bus interface card detection system as claimed in claim 1, wherein the plurality of parameters read by the reading unit comprise a present bandwidth value and a maximum bandwidth value.

6. A method for detecting at least one bus interface card of an electronic device comprising steps of:
receiving a detection instruction from the electronic device and reading, by a reading unit, a plurality of parameters from the at least one bus interface card, according to the detection instruction, wherein the plurality of parameters include at least one present operating value and at least one maximum operating value corresponding to the present operating value; and
receiving the plurality of parameters from the reading unit and determining whether the at least one present operating value is greater than the corresponding at least one maximum operating value or not, according to the plurality of parameters, by a determining unit coupled with the reading unit, wherein if the at least one present operating value of the at least one bus interface card is greater than the corresponding at least one maximum operating value, the determining unit determines that the at least one bus interface card is incompatible with an operation specification supported by the electronic device.

7. The method as claimed in claim 6, wherein after the step of reading the plurality of parameters from the at least one bus interface card by the reading unit, the method further comprises a step of: receiving the plurality of parameters from the reading unit by a display controlling unit, thereby displaying the plurality of parameters on a display screen of the electronic device, wherein the display controlling unit is coupled with the reading unit and the display screen of the electronic device.

8. The method as claimed in claim 7, wherein after the step of determining the at least one bus interface card is incompatible with the operation specification supported by the electronic device by the determining unit, the method further comprises a step of: generating an alert message by an alarm unit, and transmitting the alert message to the display controlling unit by the alarm unit, thereby displaying the alert message on the display screen, wherein the alarm unit is respectively coupled with the determining unit and the display controlling unit.

9. The method as claimed in claim 6, wherein the plurality of parameters comprise a present connection speed value and a maximum connection speed value.

10. The method as claimed in claim 6, wherein the plurality of parameters comprise a present bandwidth value and a maximum bandwidth value.

11. A bus interface card detection system for detecting at least one bus interface card of an electronic device, the bus interface card detection system comprising:
a reading unit coupled with the at least one bus interface card, for receiving a detection instruction from the electronic device and reading a plurality of parameters from the at least one bus interface card according to the detection instruction, wherein the plurality of parameters include at least one present operating value and at least one maximum operating value corresponding to the present operating value;
a determining unit coupled with the reading unit, for receiving the plurality of parameters from the reading unit and determining whether the at least one present operating value is greater than the corresponding at least one maximum operating value or not, according to the plurality of parameters, wherein if the at least one present operating value of the at least one bus interface card is greater than the corresponding at least one maximum operating value, the determining unit determines that the at least one bus interface card is incompatible with an operation specification supported by the electronic device; and
an alarm unit coupled with the determining unit, wherein if the determining unit determines that the at least one bus interface card is incompatible with the operation specification supported by the electronic device, the alarm unit generates an alert message.

12. The bus interface card detection system as claimed in claim 11, wherein the bus interface card detection system further comprises a display controlling unit respectively coupled with the reading unit and a display screen of the electronic device, the display controlling unit is used for receiving the plurality of parameters from the reading unit, thereby displaying the plurality of parameters on the display screen of the electronic device.

13. The bus interface card detection system as claimed in claim 11, wherein the plurality of parameters read by the reading unit comprise a present connection speed value and a maximum connection speed value.

14. The bus interface card detection system as claimed in claim 11, wherein the plurality of parameters read by the reading unit comprise a present bandwidth value and a maximum bandwidth value.
